(19) United States
(12) Patent Application Publication
(10) Pub. No.: US 2010/0299461 A1
(43) Pub. Date: Nov. 25, 2010

(54) INFORMATION PROCESSING APPARATUS AND IMAGE FORMING APPARATUS

(75) Inventor: Yoshihiro Osada, Osaka (JP)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: KYOCERA MITA CORPORATION, Osaka (JP)

(21) Appl. No.: 12/761,947

(22) Filed: Apr. 16, 2010

(30) Foreign Application Priority Data
May 20, 2009 (JP) 2009-122423

(51) Int. Cl. G06F 5/06; G06F 13/36; G06F 13/00

(52) U.S. Cl. 710/57; 710/310; 710/108

(57) ABSTRACT

An information processing apparatus includes a processing unit and a control unit connected with the processing unit through a transmission line. The processing unit has multiple devices including a predetermined low-speed device. The control unit has a processing circuit that issues access to the multiple devices of the processing unit, and the processing unit has a communication circuit that receives the access to the multiple devices through the transmission line and a queue that buffers the access, when the received access is to the predetermined low-speed device.

### INCORPORATION BY REFERENCE

This application is based upon and claims the benefit of priority from corresponding Japanese Patent application No. 2009-122423, filed May 20, 2009, the entire contents of which is incorporated herein by reference.

### FIELD OF THE INVENTION

The present invention relates to an information processing apparatus and an image forming apparatus.

### BACKGROUND OF THE INVENTION

In recent years, as high-speed transmission technology has advanced, various types of data communications take place through shared, non-dedicated high-speed transmission lines. As the efficiency of using such high-speed transmission lines increases, their use becomes more widespread.

For example, in the field of inter-chip transmission, high-speed serial transmission systems, such as those from RapidIO, HyperTransport, and PCI-Express systems, are commercially available. The use of such a transmission system allows all inter-chip transmissions to be performed through one transmission channel. For example, high-speed data communication, low-speed data communication (e.g. for configuration setting), and interrupt signaling are performed through a single high-speed transmission line.

Bus bridges are available to connect a high-speed bus (to which a control circuit, such as a processor, may be connected) with a low-speed bus (to which a peripheral device may be connected). The control circuit transmits access to the peripheral device (the access includes an address, a command, and data for writing to a control register in the peripheral device) to the bus bridge through the high-speed bus.

However, consider, for example, a case in which a processing unit serving as a peripheral device has a memory that allows high-speed access and a control register that allows only low-speed access. When access to the control register is excessive, there is a possibility that the access to the memory is limited or blocked.

In such a case, even though high-speed data transfer is supposed to be possible between bus bridges that provide connection between a control circuit and a processing unit, such high-speed data transfer may be interrupted due to low-speed access congestion.

Another signal line for low-speed access may be provided so that low-speed access congestion does not cause interruption of high-speed data transfer. Such an arrangement, however, requires providing the signal line and a communication circuit, and thus, is not preferable in terms of the cost and circuit scale.

The arrangement may also be such that the bus bridges establish multiple logical channels through a transmission line and control the logical channels completely independently from each other. Such an arrangement, however, complicates the bus-bridge processing and configuration, and thus, is not preferable in terms of the cost and circuit scale.

### SUMMARY OF THE INVENTION

One aspect of the present invention provides an information processing apparatus. The information processing apparatus includes a processing unit and a control unit connected with the processing unit through a transmission line. The processing unit has multiple devices including a predetermined low-speed device. The control unit has a processing circuit that issues access to the multiple devices of the processing unit. The processing unit has a communication circuit that receives the access to the multiple devices through the transmission line and a queue that buffers the access when the received access is to the predetermined low-speed device.

Another aspect of the present invention provides an image forming apparatus. The image forming apparatus includes an image processing unit, an image forming unit, and a control unit. The image processing unit has multiple devices, including a predetermined low-speed device, to process an image. The image forming unit forms the processed image on a predetermined recording medium. The control unit is connected with the image processing unit through a transmission line and has a processing circuit that issues access to the multiple devices of the image processing unit. The image processing unit has a communication circuit that receives the access to the multiple devices through the transmission line and a queue that buffers the access when the received access is to the predetermined low-speed device.

Still another aspect of the present invention provides an information processing method. The information processing method includes the steps of: issuing access to multiple devices of a processing unit connected with a control unit through a transmission line, the multiple devices including a predetermined low-speed device; receiving the access to the multiple devices through the transmission line; and buffering the access when the received access is to the predetermined low-speed device.

The various features of novelty that characterize the invention are pointed out in particularity in the claims annexed to and forming a part of this disclosure. For a better understanding of the invention, its operating advantages and specific objects attained by its uses, reference is made to the accompanying descriptive matter in which exemplary embodiments of the invention are illustrated in the accompanying drawings, in which corresponding components are identified by the same reference numerals.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 is a block diagram illustrating the configuration of an information processing apparatus according to a first embodiment of the present invention;

FIG. 2 is a block diagram illustrating the configuration of an information processing apparatus according to a second embodiment of the present invention;

FIG. 3 is a block diagram illustrating the configuration of an information processing apparatus according to a third embodiment of the present invention; and

FIG. 4 is a block diagram illustrating the configuration of an image forming apparatus having the information processing apparatus according to one of the first to third embodiments of the present invention.

### DETAILED DESCRIPTION OF THE EMBODIMENTS

Reference will now be made in detail to various embodiments of the invention, one or more examples of which are illustrated in the accompanying drawings. Each example is provided by way of explanation of the invention, and by no way limiting the present invention. In fact, it will be apparent to those skilled in the art that various modifications, combinations, additions, deletions and variations can be made in the present invention without departing from the scope or spirit of the present invention. For instance, features illustrated or described as part of one embodiment can be used in another embodiment to yield a still further embodiment. It is intended that the present invention covers such modifications, combinations, additions, deletions, applications and variations that come within the scope of the appended claims and their equivalents. Preferred embodiments of the information processing apparatus and image forming apparatus of the present invention will now be described in detail according to constitutional features.

Embodiments of the present invention will be described below with reference to the accompanying drawings.

As used herein, the term “access” when used as a noun, generally refers to a request for access, which may comprise a message having data relating to the request for access.

### First Embodiment

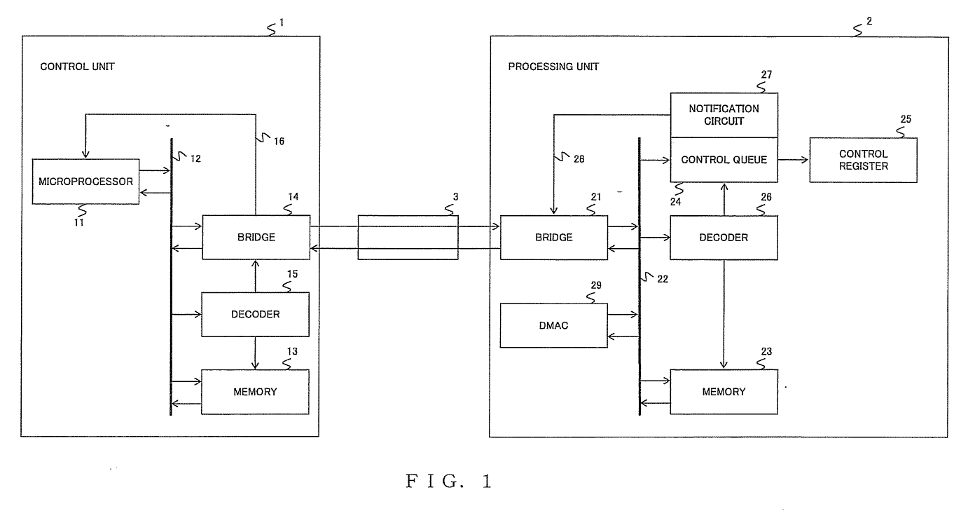

FIG. 1 is a block diagram illustrating the configuration of an information processing apparatus according to a first embodiment of the present invention.

In FIG. 1, a control unit 1 is connected to a processing unit 2 through a high-speed transmission line 3 to use devices of the processing unit 2. The devices of the processing unit 2 include a high-speed access device and a low-speed access device. The high-speed transmission line 3 is a transmission medium that is capable of transferring data at high speed. The ratio of the high-speed access speed to the low-speed access speed is, for example, in a range of about 10 or 100 to 1.

The control unit 1 and the processing unit 2 may be implemented as units having housings that are independent from each other or as semiconductor chips that are independent from each other. When the control unit 1 and the processing unit 2 are implemented as independent semiconductor chips, they may be provided on a single substrate or on discrete substrates.

The control unit 1 includes a microprocessor 11, a bus 12, a memory 13, a bridge 14, a decoder 15, and a signal line 16. The microprocessor 11, the memory 13, the bridge 14, and the decoder 15 are connected to the bus 12.

The microprocessor 11 serves as a circuit that operates according to a program to perform computations for predetermined control and processing. The microprocessor 11 also serves as a processing circuit that issues access to the devices (e.g., the memory 13 and the bridge 14) connected to the bus 12 in the control unit 1 and the devices connected to a bus 22 in the processing unit 2. The bus 12 includes a data bus, an address bus, and a control bus. The access issued by the microprocessor 11 includes data, an address, and a command (control signal).

The memory 13 serves as a storage device, such as a RAM (random access memory) that allows high-speed access. The memory 13 may be provided outside the control unit 1.

The bridge 14 serves as a device (a bus bridge) that relays data between the bus 12 and the high-speed transmission line 3.

The decoder 15 is connected to the address bus of the bus 12 and serves as a circuit that converts an address of the access issued from the microprocessor 11 and that supplies the converted address to the memory 13 or the bridge 14 in accordance with the value of the converted address.

The signal line 16 is an interrupt signal line for the microprocessor 11. The signal line 16 is connected to the bridge 14 and is used to receive an exception from the processing unit 2.

The processing unit 2 includes a bridge 21, the bus 22, a memory 23, a control queue 24, a control register 25, a decoder 26, a notification circuit 27, a signal line 28, and a direct memory access controller (DMAC) 29. The bridge 21, the memory 23, the control queue 24, the decoder 26, and the DMAC 29 are connected to the bus 22.

The bridge 21 serves as a device that relays data between the bus 22 and the high-speed transmission line 3.

The memory 23 serves as a storage device, such as a RAM, that is high-speed accessible. The memory 23 is a main memory of the processing unit 2. The memory 23 may be provided outside the processing unit 2.

The control queue 24 is a FIFO (First In, First Out) queue, also known as a “FIFO”, and serves as a device that receives accesses to the control register 25 from the control unit 1, sequentially buffers the accesses, and sequentially supplies the accesses to the control register 25.

The control register 25 serves as a storage element that stores values corresponding to commands issued to a device (not shown) provided in the processing unit 2 and a device (not shown) connected to the processing unit 2. The microprocessor 11 writes the values to the control register 25 and controls such devices.

The decoder 26 is connected to an address bus of the bus 22 and serves as a circuit that converts an address of the access received through the bridge 21 and that supplies the converted address to the memory 23 or the control queue 24 in accordance with the value of the converted address.

The notification circuit 27 monitors the usage rate of the control queue 24. When the access to the control register 25 is stored to exceed a predetermined rate of the capacity of the control queue 24, the notification circuit 27 transmits a notification to the control unit 1. This notification is transmitted as an interrupt to the microprocessor 11 through the signal line 28, the bridge 21, the high-speed transmission line 3, the bridge 14, and the signal line 16.

The DMAC 29 serves as a control circuit that accesses the memory 13 in the control unit 1 through the bus 22, the bridge 21, the high-speed transmission line 3, the bridge 14, and the bus 12 to perform high-speed data transfer. The DMAC 29 operates independently from the microprocessor 11.

The operation of the above-described apparatus will be described next.

The microprocessor 11 outputs write access or read access to the bus 12. For access to the memory 13, the microprocessor 11 accesses the memory 13 through the bus 12. On the other hand, for access to the control register 25, the access is transmitted from the bridge 14 to the bridge 21 through the high-speed transmission line 3, is sent to the control queue 24 through the bus 22, and is queued in the control queue 24. The control queue 24 provides access to the control register 25 in a FIFO order. For access to the memory 23, the access is transmitted from the bridge 14 to the bridge 21 through the high-speed transmission line 3 and is supplied to the memory 23 through the bus 22.

For write access, the microprocessor 11 operates in a store-and-forward mode. That is, immediately after outputting data to be written to the bus 12, the microprocessor 11 proceeds to a next instruction. On the other hand, for read access, when the microprocessor 11 is to use a read result for a next instruction, it stops instruction execution and waits until the read result arrives. The microprocessor 11 sequentially issues accesses to perform processing and control.

In the processing unit 2, the notification circuit 27 monitors the number of accesses stored in the FIFO of the control queue 24. When the ratio of the number of accesses currently stored therein to the number of accesses that can be stored in the FIFO exceeds a predetermined first threshold (e.g., 80%), the notification circuit 27 outputs a first notification. The first notification arrives at the microprocessor 11 as an interrupt. In response to the interrupt, the microprocessor 11 prohibits accessing the control register 25. Thus, the microprocessor 11 switches a current task to another task or an idle task. Thereafter, when the ratio of the number of accesses currently stored therein to the number of accesses that can be stored in the FIFO falls below a predetermined second threshold (e.g., 20%), the notification circuit 27 outputs a second notification. The second notification arrives at the microprocessor 11 as an interrupt. In response to the interrupt, the microprocessor 11 cancels the prohibition of accessing the control register 25 and switches the current task to the original task.

Since the number of stages in the FIFO in the control queue 24 is determined considering the frequency of accessing the control register 25, the possibility of the FIFO of the control queue 24 being filled is generally low. In addition, since the notification issued from the notification circuit 27 restricts the access to the control register 25 before the FIFO is filled, the FIFO is not filled.

As described above, according to the first embodiment, the control queue 24 buffers the access to the low-speed control register 25. With this arrangement, even when low-speed accesses from the control unit 1 to the processing unit 2 continue, the accesses are accumulated in the control queue 24 to thereby make it possible to prevent interference of high-speed data transfer (such as access from the microprocessor 11 to the memory 23 and access from the DMAC 29 to the memory 13) between the control unit 1 and the processing unit 2 without stalling the bridge 21, etc. In addition, since a bridge that is the same as or similar to a currently available bridge can be used as the bridge 21, there is no need to make substantial changes in design.

According to the first embodiment described above, the notification circuit 27 monitors the usage rate of the control queue 24, and when the access to the control register 25 is stored to exceed a predetermined rate of the capacity of the control queue 24, the notification circuit 27 transmits a notification to the control unit 1. Upon receiving the notification, the control unit 1 prohibits issuing access to the control register 25. Consequently, the access to the control register 25, the access being issued from the control unit 1 to the processing unit 2, is restrained before the access overflows from the control queue 24 to cause the bridge 21 to stall. Thus, it is possible to prevent interference of high-speed data transfer between the control unit 1 and the processing unit 2 without stalling of the bridge 21 and so on.

### Second Embodiment

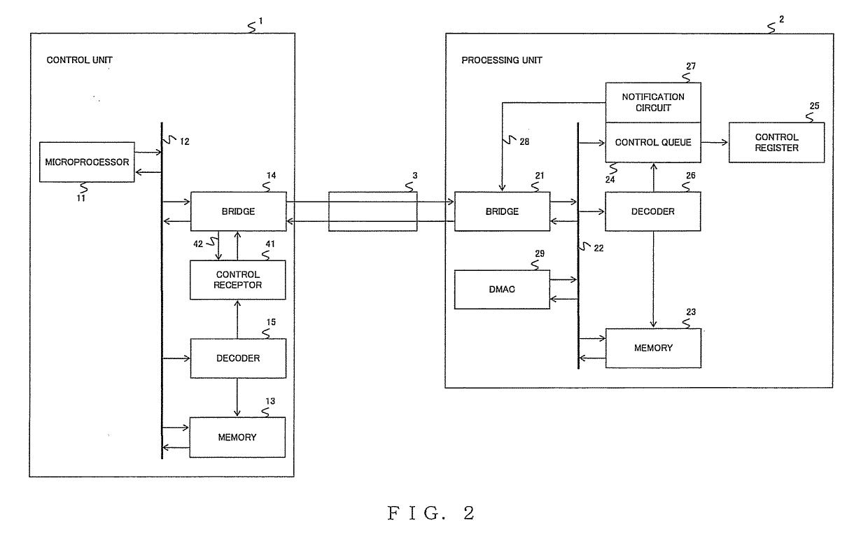

FIG. 2 is a block diagram illustrating the configuration of an information processing apparatus according to a second embodiment of the present invention. In the second embodiment, the control unit 1 further includes a control receptor 41 and a signal line 42. Since other elements in FIG. 2 are analogous to those in the first embodiment (FIG. 1), descriptions thereof are not given hereinafter.

The control receptor 41 receives the first and second notifications from the bridge 14 through the signal line 42. Upon receiving the first notification, the control receptor 41 starts blocking access to the control register 25 between the decoder 15 and the bridge 14. Thereafter, upon receiving the second notification, the control receptor 41 cancels the blocking of access to the control register 25. In this case, access to the memory 23 is not blocked.

### Third Embodiment

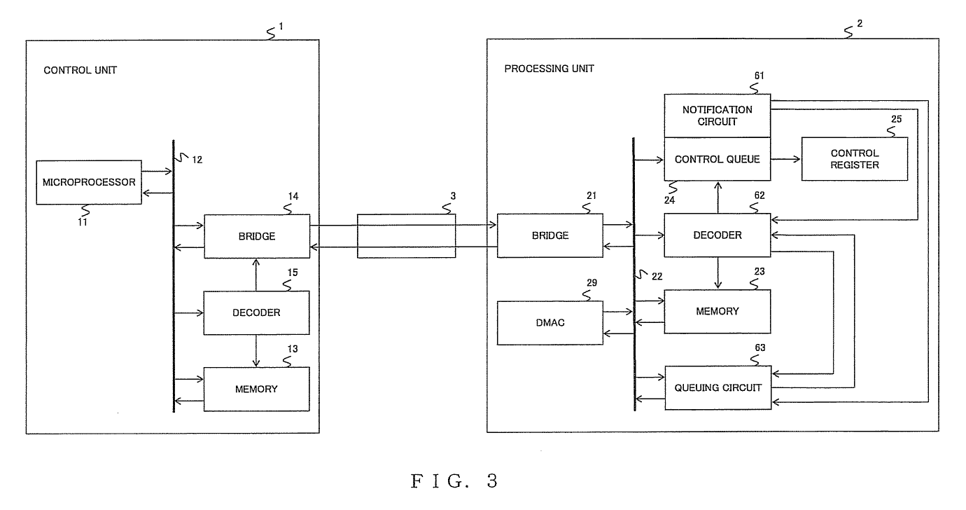

FIG. 3 is a block diagram illustrating the configuration of an information processing apparatus according to a third embodiment of the present invention. In the third embodiment, a notification circuit 61 is provided instead of the notification circuit 27, a decoder 62 is provided instead of the decoder 26, and a queuing circuit 63 is further provided. Since other elements in FIG. 3 are analogous to those in the first embodiment (FIG. 1), descriptions thereof are not given hereinafter.

In the third embodiment, when the FIFO of the control queue 24 is filled, access to the control register 25 is temporarily stored in the memory 23, which has a large capacity.

When the FIFO of the control queue 24 is filled, the notification circuit 61 sends the first notification to the decoder 62 and the queuing circuit 63. Upon receiving the first notification, the decoder 62 converts the address of the access to the control register 25 so that the access is received by the queuing circuit 63. When the queuing circuit 63 receives access to the control register 25 after receiving the first notification, the queuing circuit 63 sequentially stores the received access in a predetermined storage area in the memory 23. Thereafter, when the ratio of the number of accesses currently stored therein to the number of accesses that can be stored in the FIFO of the control queue 24 falls below the predetermined second threshold (e.g., 20%), the notification circuit 61 sends a second notification to the queuing circuit 63. Upon receiving the second notification, the queuing circuit 63 sequentially reads the accesses stored in the memory 23 and writes the read accesses to the control queue 24.

When the access stored in the memory 23 is completely read out, the queuing circuit 63 sends a third notification to the decoder 62. Upon receiving the third notification, the decoder 62 converts the address of the access to the control register 25 so that the access is received by the control queue 24.

As described above, according to the third embodiment, when the control queue 24 is filled with accesses to the control register 25 and access to the control register 25 is further received, the queuing circuit 63 queues the received access in the memory 23. Thus, even when the control queue 24 is filled with accesses, it is possible to prevent interference of high-speed data transfer between the control unit 1 and the processing unit 2 without stalling the bridge 21, etc.

While the embodiments described above are preferred examples of the present invention, the present invention is not limited thereto, and thus, various modifications and changes can be made thereto without departing from the spirit and scope of the present invention.

For example, in the first and second embodiments described above, the notifications issued from the notification circuit 27 to the control unit 1 may be transmitted through another channel.

In the above-described embodiments, the memory 23 or the like may have a storage section that stores data containing a maximum value of the number of stages used in the control queue 24. For example, the arrangement may be such that the value of the data is reset to zero before an application is executed and the value of the data is referred to after the application is executed. Such an arrangement makes it possible to pre-check, for example, whether or not the number of stages in the FIFO of the control queue 24 is sufficient or whether or not the access from the application to the control register 25 is appropriate. The storage section may store not only the maximum value of the number of stages used but also the number of all stages used.

Although the control register 25 is provided in the processing unit 2 as a low-speed device in the embodiments described above, a serial communication circuit may be provided as the low-speed device. In such a case, provision of the control queue 24 between the serial communication circuit and the bus 22 can offer the same advantage.

In the above-described embodiments, the processing unit 2 may have a bridge for connection with a low-speed bus. In such a case, provision of the control queue 24 between the bridge and the bus 22 can offer the same advantage. With such an arrangement, the processing unit 2 functions as a bus bridge unit.

In the first and second embodiments described above, the notification circuit 27 may periodically issue a notification indicating the usage rate of the control queue 24.

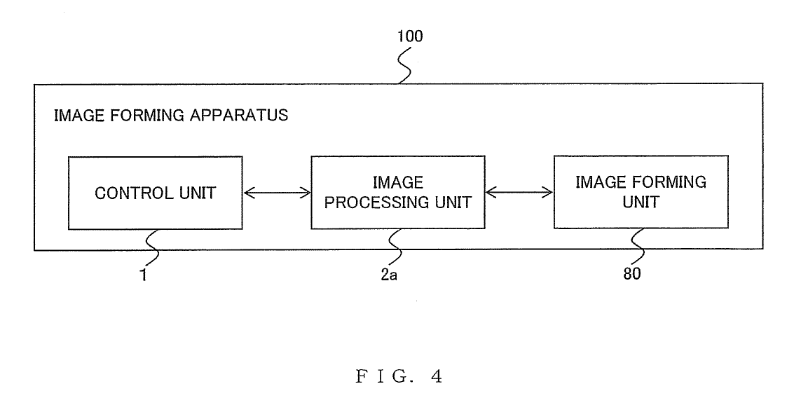

The information processing apparatus of each of the above-described embodiments is applicable to image forming apparatuses, such as printers and multifunctional equipment. For example, addition of a newly designed processing unit 2 is advantageous for addition of a function of an image forming apparatus. FIG. 4 shows one example of such a configuration. An image forming apparatus 100 shown in FIG. 4 has at least the control unit 1, an image processing unit 2a (which is one example of the processing unit 2) for processing an image, and an image forming unit 80 for forming the processed image on a predetermined recording medium (such as paper).

Having thus described in detail preferred embodiments of the present invention, it is to be understood that the invention defined by the foregoing paragraphs is not to be limited to particular details and/or embodiments set forth in the above description, as many apparent variations thereof are possible without departing from the spirit or scope of the present invention.

What is claimed is:

1. An information processing apparatus comprising:
a processing unit having multiple devices including a predetermined low-speed device; and
a control unit connected with the processing unit through a transmission line;
wherein the control unit has a processing circuit that issues access to the multiple devices of the processing unit, and
wherein the processing unit has (a) a communication circuit that receives the access to the multiple devices through the transmission line and (b) a queue that buffers the access when the received access is to the predetermined low-speed device.

2. The information processing apparatus according to claim 1, wherein the processing unit has a notification circuit that monitors a usage rate of the queue and that transmits a notification to the control unit when the access to the predetermined low-speed device is stored at a rate that exceeds a predetermined rate of a capacity of the queue; and
wherein upon receiving the notification, the control unit prohibits issuing access to the predetermined low-speed device.

3. The information processing apparatus according to claim 2, wherein upon receiving the notification, the processing circuit in the control unit prohibits issuing access to the predetermined low-speed device.

4. The information processing apparatus according to claim 2, wherein the control unit has a blocking circuit, and wherein, upon the control unit receiving the notification, the blocking circuit blocks access to the predetermined low-speed device.

5. The information processing apparatus according to claim 1, wherein one of the multiple devices comprises a main memory, and wherein the processing unit has a queuing circuit that queues in the main memory a further access to the predetermined low-speed device received after the queue is filled with the access to the predetermined low-speed device.

6. The information processing apparatus according to claim 1, wherein one of the multiple devices comprises a main memory having a storage section that stores a number of stages used in the queue.

7. The information processing apparatus according to claim 6, wherein the storage section stores a maximum value of the number of stages used in the queue.

8. The information processing apparatus according to claim 6, wherein the storage section is reset before predetermined processing is executed, and is referenced after the predetermined processing is executed.

9. An image forming apparatus comprising:
an image processing unit having multiple devices, including a predetermined low-speed device, for processing an image;
an image forming unit that forms the processed image on a predetermined recording medium; and
a control unit connected with the image processing unit through a transmission line and having a processing circuit that issues access to the multiple devices of the image processing unit;
wherein the image processing unit has (a) a communication circuit that receives the access to the multiple devices through the transmission line and (b) a queue that buffers the access when the received access is to the predetermined low-speed device.

10. The image forming apparatus according to claim 9, wherein the image processing unit has a notification circuit that monitors a usage rate of the queue and that transmits a notification to the control unit when the access to the predetermined low-speed device is stored at a rate that exceeds a predetermined rate of a capacity of the queue; and
wherein upon receiving the notification, the control unit prohibits issuing access to the predetermined low-speed device.

11. The image forming apparatus according to claim 10, wherein upon receiving the notification, the processing circuit in the control unit prohibits issuing access to the predetermined low-speed device.

12. The image forming apparatus according to claim 10, wherein the control unit has a blocking circuit, and wherein, upon the control unit receiving the notification, the blocking circuit blocks access to the predetermined low-speed device.

13. The image forming apparatus according to claim 9, wherein one of the multiple devices comprises a main memory, and wherein the image processing unit has a queuing circuit that queues in the main memory a further access to the predetermined low-speed device received after the queue is filled with the access to the predetermined low-speed device.

14. The image forming apparatus according to claim 9, wherein one of the multiple devices comprises a main memory having a storage section that stores a number of stages used in the queue.

15. The image forming apparatus according to claim 14, wherein the storage section stores a maximum value of the number of stages used in the queue.

16. The image forming apparatus according to claim 14, wherein the storage section is reset before predetermined processing is executed, and is referenced after the predetermined processing is executed.

17. An information processing method comprising the steps of:
issuing access to multiple devices of a processing unit connected with a control unit through a transmission line, the multiple devices including a predetermined low-speed device;
receiving the access to the multiple devices through the transmission line; and
buffering the access when the received access is to the predetermined low-speed device.

18. The information processing method according to claim 17, further comprising:
monitoring a rate at which the access is buffered; and
prohibiting access to the predetermined low-speed device when the access to the predetermined low-speed device is buffered at a rate that exceeds a predetermined capacity.

19. The information processing method according to claim 17, wherein the buffering is performed using a FIFO queue, and wherein one of the multiple devices comprises a main memory having a storage section that stores a number of stages used in the queue.

20. The information processing method according to claim 19, further comprising:
resetting the storage section before predetermined processing is executed; and
referencing the storage section after the predetermined processing is executed.
